(19) United States
(12) Patent Application Publication
(10) Pub. No.: US 2008/0049255 A1
(43) Pub. Date: Feb. 28, 2008

(54) PRINTING APPARATUS AND CONTROL METHOD THEREOF

(75) Inventor: Masayuki Yokota, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/844,158

(22) Filed: Aug. 23, 2007

(30) Foreign Application Priority Data
Aug. 28, 2006 (JP) 2006-230198

(51) Int. Cl. G06F 15/00

(52) U.S. Cl. 358/1.18

(57) ABSTRACT

It is an object to provide a printing apparatus and a control method thereof that enable printing at an image quality that a user intends when a plurality of print jobs are laid out to be printed. A printing apparatus laying out a plurality of print jobs to perform printing on paper includes a print job number setting unit for setting the number of layout target print jobs. Moreover, the present invention concerns a printing apparatus characterized by including a layout target job determination unit for determining layout target print jobs according to the print conditions of the print jobs.

### BACKGROUND OF THE INVENTION

1. Field of the Invention

In a market, such as a print on demand (POD) market, in which a low running cost is regarded as important, a large-sized sheet of paper is installed in a printing apparatus, and a plurality of print jobs are laid out on the sheet of paper to be printed. Paper-saving can be thereby realized, and the paper-saving is important. The present invention relates to such a printing apparatus.

2. Description of the Related Art

Conventionally, if a plurality of print jobs are laid out to be printed in a lump by a printing apparatus, the print jobs received from a host computer have been laid out as layout target jobs in a time set in a printing apparatus in advance and have been printed in a lump.

As a printing apparatus performing such an operation, DJ5500 available from Hewlett-Packard Company is known.

Moreover, a proposal pertaining to a layout is disclosed (see Japanese Patent Application Laid-Open No. 2001-189846). However, this Patent Document 1 does not disclose how to determine the layout target print jobs.

Conventionally, if a plurality of print jobs are laid out to be printed in a lump by a printing apparatus, the print jobs received from a host computer have been laid out as layout target jobs in a time set in the printing apparatus in advance. Then, the laid-out print jobs have been printed in a lump.

Moreover, although the Japanese Patent Application Laid-Open No. 2001-189846 discloses the proposal pertaining to a layout, it does not disclose how to determine layout target print jobs, as described above.

Consequently, when the printing apparatus performs layout print in accordance with the related art, the printing apparatus performs the layout print in a lump even if the specifications of a print quality and a paper type to each print job are different from each other. The related art printing apparatus has a problem of the impossibleness of obtaining an image quality that a user originally desires.

### SUMMARY OF THE INVENTION

It is an object of the present invention to provide a printing apparatus and a control method thereof that enables printing in an image quality that a user intended when the printing is performed by laying out a plurality of print jobs.

A first aspect of the present invention is a printing apparatus capable of printing a plurality of print jobs in a laid-out state on a sheet of paper, the printing apparatus includes a print job number setting unit for setting a number of layout target print jobs; and a layout target job determination unit for determining the layout target print jobs according to the number of the print jobs set by the print job number setting unit and print conditions of the print jobs.

A second aspect of the present invention is a control method of a printing apparatus capable of printing a plurality of print jobs in a laid-out state on a sheet of papers the method including the steps of: setting a number of layout target print jobs; and determining the layout target print jobs according to the number of the print jobs set at the setting step and print conditions of the print jobs.

Further features of the present invention will become apparent from the following description of exemplary embodiments with reference to the attached drawings.

### BRIEF DESCRIPTION OF THE DRAWINGS

FIG. 1 is a block diagram illustrating a printing apparatus 100 of an exemplary embodiment 1 of the present invention.

FIG. 2 is a flow chart illustrating the print control operation of the exemplary embodiment.

FIG. 3 is a diagram illustrating an example of managing layout target print jobs by paper types in the exemplary embodiment.

FIG. 4 is a view illustrating laid-out print jobs in the exemplary embodiment.

### DESCRIPTION OF THE EXEMPLARY EMBODIMENT

The best mode for implementing the present invention is the next exemplary embodiment.

### Exemplary Embodiment 1

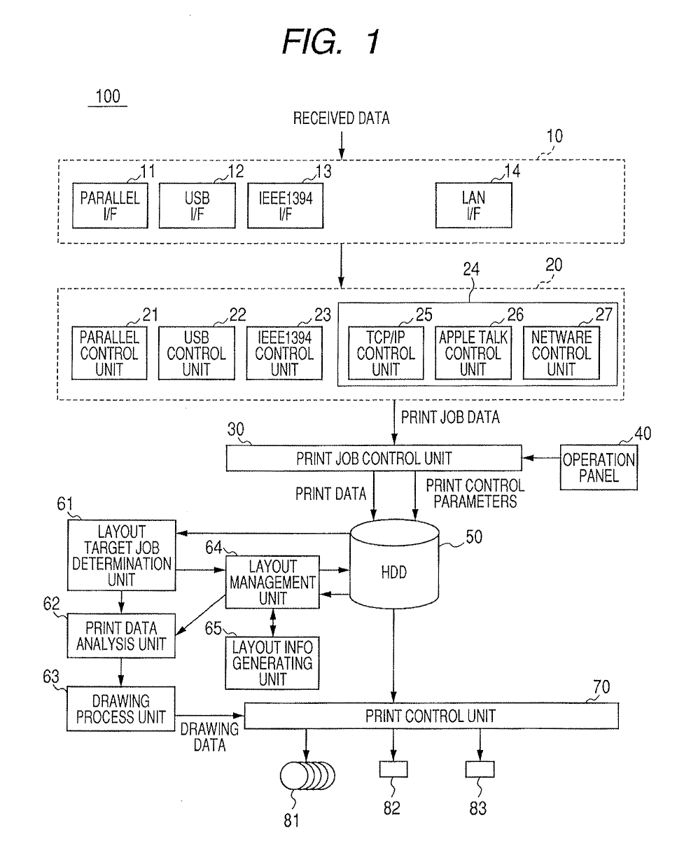

FIG. 1 is a block diagram illustrating a printing apparatus 100, which is an exemplary embodiment 1 of the present invention.

The printing apparatus 100 is a roll paper printing apparatus of the ink-jet system, and includes a host interface 10, a transfer control unit 20, a print job control unit 30, an operation panel 40, and a HDD 50. Moreover, the printing apparatus 100 includes a layout target job determination unit 61, a print data analysis unit 62, a drawing process unit 63, and a layout management unit 64. Furthermore, the printing apparatus 100 includes a layout information generating unit 65, a print control unit 70, a motor 81, a print head 82, and an ink supply unit 83.

The host interface 10 is provided with a parallel I/F 11, a USB I/F 12, an IEEE 1394 I/F 13, and a LAN I/F 14.

The transfer control unit 20 is provided with a parallel control unit 21, a USB control unit 22, an IEEE 1394 control unit 23, and a LAN control unit 24.

The protocol of the LAN control unit 24 supports TCP/IP 25, AppleTalk 26, and NetWare 27.

Incidentally, the operation panel 40 is an example of a print job number setting unit for setting the number of layout target print jobs.

The layout target job determination unit 61 is an example of a layout target job determination unit for determining layout target print jobs according to the print conditions of the print jobs. The layout target job determination unit is a unit for determining layout target print jobs according to at least a paper size, a paper type, and a print quality in the print conditions. Moreover, the print quality is a quality composed of at least the number of print passes, a carriage speed, and a print direction.

If the type of the paper installed in the printing apparatus 100 is different from that of the type of the paper on which printing is intended to be performed when the layout target job determination unit determines the number of print jobs which has been set by the print job number setting unit, a message for urging the replacement of paper is displayed on the display unit of the operation panel 40.

Next, the operation of the exemplary embodiment mentioned above is described.

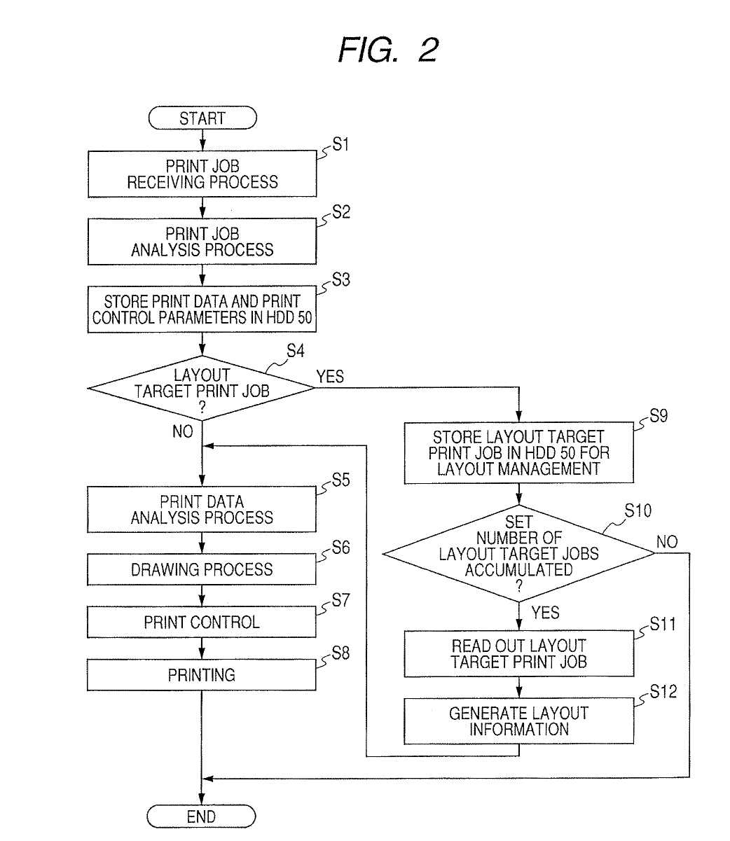

FIG. 2 is a flow chart illustrating the print control operation of the exemplary embodiment.

First, the print job data received from a not-shown host computer is transferred to the print job control unit 30 through the host interface 10 and the transfer control unit 20 (Step S1).

The print job control unit 30 analyzes the print job (Step S2), and transfers print control parameters to the print control unit 70. Furthermore, the print job control unit 30 stores the print data in the print job into the HDD 50 (Step S3).

The layout target job determination unit 61 reads out the print data stored in the HDD 50, and compares the specified paper size with an actual size of a sheet of paper installed in the printing apparatus to determine whether the print data is relevant to the layout target print job (Step S4).

If the print data is determined not to be relevant to the layout target print job (Step S4), the print data is transferred to the print data analysis unit 62 to be analyzed (Step S5). Then, drawing data is generated, and drawing process unit 63 performs a drawing process (Step S6).

Then, the drawing data drawn by the drawing process unit 63 is transferred to the print control unit 70, and print control is performed in accordance with the print control parameters (Step S7).

The print control by the print control unit 70 controls the drive of the motor 81 for performing a head movement, paper conveyance, and the like, controls the discharge of ink from the print head 82, and controls an ink supply system 83 for supplying ink to the print head 82 (Step S8).

At this time, the print control unit 70 controls the printing in accordance with the print control parameters stored in the HDD 50 (Step S7). The print control parameters include at least the number of print passes, a carriage speed, and a print direction. The speed of the carriage, on which a head is installed, the number of passes of the head, the selection of one-way printing or two-way printing, and the like, are controlled.

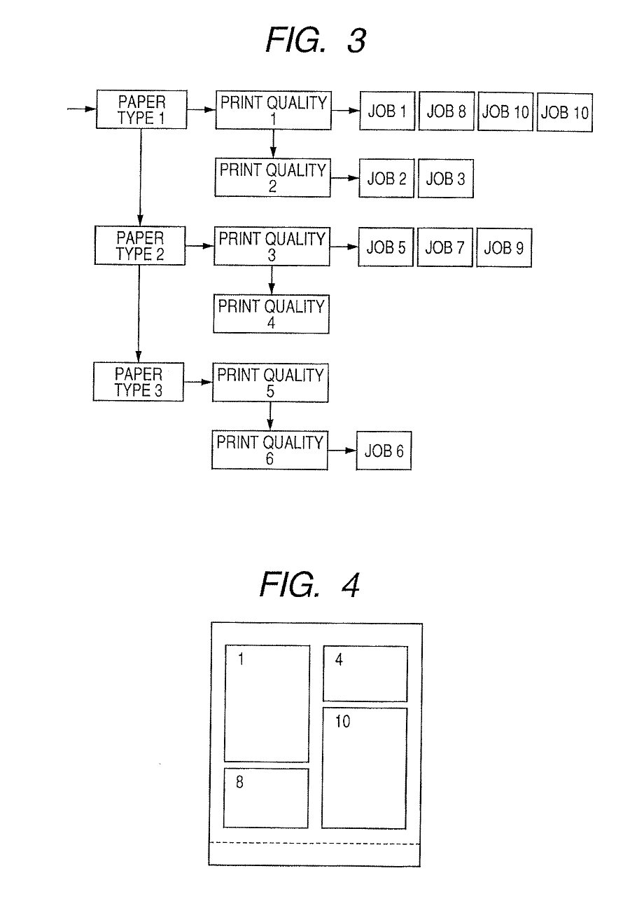

FIG. 3 is a diagram illustrating an example of managing the layout target print jobs by paper types in the exemplary embodiment.

On the other hand, when the layout target job determination unit 61 determines the print data to be a layout target job (Step S4), the determined print job is stored in the HDD 50 through the layout management unit 64 (Step S9). If the print data is stored in such a way, the layout target job management illustrated in FIG. 3 is performed. The layout management performs classification by paper types, and further manages print jobs according to print qualities at a hierarchy lower than the paper types.

When the jobs are accumulated as many as the number of layout target jobs set from the operation panel 40 (Step S10), the layout management unit 64 performs the read-out thereof (Step S11), and the layout information generating unit 65 generates layout information (Step S12). After that, the layout information and the print data are transferred to the data analysis unit 62, and the process proceeds to the Step S5.

FIG. 4 is a view illustrating an example of laying out print jobs in the exemplary embodiment.

Drawing information for the layout is then generated, and the drawing process unit 63 performs a drawing process (Step S6). Similarly to the case where the determination of not being the layout print is performed, print control is performed through the print control unit 70 (Step S7), and the layout print shown in the layout view of FIG. 4 is performed (Step S8).

If the type of the paper installed in the printing apparatus differs from the type of the paper on which printing is intended to be performed when the layout target job determination unit has determined the number of print jobs which number the print job number setting unit has set, a message urging the replacement of the paper is displayed on the display unit of the operation panel.

According to the exemplary embodiment, layout target print jobs are determined according to a paper type, a paper size, and a print quality. Consequently, if a plurality of print jobs are laid out to be printed, printing can be performed in the image quality that a user intends.

That is, according to the exemplary embodiment, because the print jobs under the same print conditions are printed in a lump, both of the print quality that a user desires and paper saving can be managed to be achieved.

Moreover, according to the exemplary embodiment, because the number of print jobs is set through the operation panel of the printing apparatus, the number of layout target print jobs to be printed under the same print conditions can be set.

Furthermore, according to the exemplary embodiment, because the layout target job determination unit determines layout target jobs on the basis of at least a paper size, a paper type, and a print quality in the print conditions, printing can be performed on the paper having the same paper type in the same print quality.

According to the exemplary embodiment, because the print quality is composed of at least a number of print passes, a carriage speed, and a print direction, printing can be performed under the same print conditions.

Moreover, according to the exemplary embodiment, because a message urging the replacement of paper is displayed if the type of the paper installed in the printing apparatus is different from the type of the paper on which printing is intended to be performed when print jobs are determined, layout printing can be performed on the paper that a user desires.

Furthermore, according to the exemplary embodiment, with a roll paper printing apparatus of the ink-jet system that is a printing apparatus capable of printing a large size character, such as a large-sized printer, layout printing can be performed on the paper having the same paper type in the same print quality.

While the present invention has been described with reference to exemplary embodiment, it is to be understood that the invention is not limited to the disclosed exemplary embodiment. The scope of the following claims is to be accorded the broadest interpretation so as to encompass all such modifications and equivalent structures and functions.

This application claims the benefit of Japanese Patent Application No. 2006-230198, filed Aug. 28, 2006, which is hereby incorporated by reference herein in its entirety.

What is claimed is:

1. A printing apparatus capable of printing a plurality of print jobs in a laid-out state on a sheet of paper, the apparatus comprising:
a print job number setting unit for setting a number of layout target print jobs; and
a layout target job determination unit for determining the layout target print jobs according to the number of the print jobs set by the print job number setting unit and print conditions of the print jobs.

2. The printing apparatus according to claim 1, wherein the print job number setting unit is a unit setting the number of the pint jobs through an operation panel of the printing apparatus.

3. The printing apparatus according to claim 1, wherein the layout target job determination unit is a unit determining the layout target print jobs according to at least a paper size, a paper type, and a print quality in the print conditions.

4. The printing apparatus according to claim 3, wherein the print quality is a quality composed of at least a number of print passes, a carriage speed, and a print direction.

5. The printing apparatus according to claim 2, further comprising a paper replacement instruction unit for displaying a message for urging replacement of paper on a display unit of the operation panel if a type of the paper installed in the printing apparatus differs from a type of paper on which printing is intended when the layout target job determination unit determines a number of print jobs, the number set by the print job number setting unit.

6. The printing apparatus according to claim 1, wherein the printing apparatus is a roll paper printing apparatus of an ink-jet system.

7. A control method of a printing apparatus capable of printing a plurality of print jobs in a laid-out state on a sheet of paper, the method comprising the steps of:
setting a number of layout target print jobs; and
determining the layout target print jobs according to the number of the print jobs set at the setting step and print conditions of the print jobs.

8. The method according to claim 7, wherein the setting step is a step of setting the number of the pint jobs through an operation panel of the printing apparatus.

9. The method according to claim 7, wherein the determining step is a step of determining the layout target print jobs according to at least a paper size, a paper type, and a print quality in the print conditions.

10. The method according to claim 9, wherein the print quality is a quality composed of at least a number of print passes, a carriage speed, and a print direction.

11. The method according to claim 8, further comprising the step of displaying a message for urging replacement of paper on a display unit of the operation panel if a type of the paper installed in the printing apparatus differs from a type of paper on which printing is intended when a number of print jobs is determined at the determining step, the number set at the setting step.

12. The method according to claim 7, wherein the printing apparatus is a roll paper printing apparatus of an ink-jet system.
